(19) United States
(12) Patent Application Publication
(10) Pub. No.: US 2021/0009070 A1
(43) Pub. Date: Jan. 14, 2021

(54) AIRBAG DEVICE

(71) Applicant: JOYSON SAFETY SYSTEMS JAPAN K.K., Tokyo (JP)

(72) Inventors: Keisuke ONOHARA, Echi-gun, Shiga (JP); Hiroki TAKEHARA, Echi-gun, Shiga (JP)

(73) Assignee: JOYSON SAFETY SYSTEMS JAPAN K.K., Tokyo (JP)

(21) Appl. No.: 17/040,270

(22) PCT Filed: Apr. 9, 2019
(86) PCT No.: PCT/JP2019/015450

§ 371 Date: Sep. 22, 2020

(30) Foreign Application Priority Data
Apr. 26, 2018 (JP) 2018-085494

(51) Int. Cl. B60R 21/203; B60R 21/23; B60R 21/26; B60R 21/215; B60R 21/261; B60R 21/217

(52) U.S. Cl. CPC B60R 21/2035; B60R 21/23; B60R 21/217; B60R 21/215; B60R 21/261; B60R 21/26

(57) ABSTRACT

The air bag device is provided with an air bag 2, an inflator 3, a retainer 10, and a diffuser 30. A bolt 21 for an attachment ring 20 is inserted into bolt insertion holes 3c provided in the air bag 2, the retainer 10, and the flange 3b of the inflator 3, and a nut 23 is engaged with the bolt 21. The diffuser 30 has a flange portion 31 which has a center opening 32 provided at the center thereof, and a side wall SW which rises from the peripheral edge of the center opening 32 and surrounds the side peripheral surface of the body of the inflator 3. The side wall SW includes a first side wall portion 34 and a second side wall portion 35 which is higher than the first side wall portion 34. The distal end of the second side wall portion 35 reaches up to a gas ejection opening 3d in the inflator 3.

### TECHNICAL FIELD

The present invention relates to an airbag device provided in a vehicle, and more particularly to an airbag device including a diffuser configured to guide a gas from an inflator.

### BACKGROUND ART

A widely used airbag device for a driver seat includes an airbag, an inflator that inflates the airbag, a retainer to which the airbag and the inflator are attached, and a module cover that covers the airbag.

The airbag and the inflator are attached to the retainer via an attachment ring including a stud bolt. A plurality of bolt insertion holes are formed around inflator openings of the airbag and the retainer. The attachment ring is provided in the airbag. The airbag and the inflator are attached to the retainer by passing each stud bolt through a respective one of the bolt insertion holes of flange portions of the airbag, the retainer, and the inflator, and fastening nuts.
Patent Literature 1: U.S. Pat. No. 8,052,167B

### SUMMARY OF INVENTION

An object of the present invention is to provide an airbag device in which a diffuser can be easily assembled to an inflator and a flow path of a gas from an inflator can be controlled.

According to an aspect of the present invention, a airbag device includes: an airbag; an inflator configured to inflate the airbag, the inflator including a body portion, a flange protruding from a side peripheral surface of the body portion, and a gas ejection port provided on the side peripheral surface of the body portion distal to the flange; a retainer to which the airbag and the inflator are attached by an attachment ring; a diffuser configured to restrict a flow direction of a gas from the inflator; and a module cover covering the airbag, in which the airbag and the retainer are respectively provided with inflator openings into which the inflator is inserted, in which the attachment ring surrounds the inflator opening in the airbag, in which the attachment ring includes a plurality of bolts that are provided upright at intervals in a circumferential direction, in which each bolt is inserted into bolt insertion holes respectively provided in the airbag, the retainer, and the flange of the inflator, and a nut is screwed, in which the diffuser includes: a flange portion that is provided with a central opening into which the inflator is inserted into a central part and that faces the flange of the inflator; a side wall that rises from a peripheral portion of the central opening of the flange portion and that surrounds the side peripheral surface of the body portion of the inflator; and a hole that is provided in the flange portion and into which the bolt is inserted, in which the side wall includes a first side wall portion and a second side wall portion having a height from the flange portion larger than that of the first side wall portion, and in which a distal end of the second side wall portion is positioned higher than the gas ejection port of the inflator.

According to another aspect of the present invention, the distal end of the second side wall portion may be positioned lower than a distal end surface of the body portion of the inflator.

According to another aspect of the present invention, a distal end of the first side wall portion may be positioned lower than the gas ejection port.

According to another aspect of the present invention, the side wall of the diffuser may be provided with no gas passage opening.

According to another aspect of the present invention, the side wall of the diffuser may have a cylindrical shape.

According to another aspect of the present invention, the flange of the inflator may be interposed between the retainer and the flange portion of the diffuser.

According to another aspect of the present invention, the side wall of the diffuser may include a plurality of small side wall portions arranged in the circumferential direction, and the flange of the inflator may be provided with insertion holes through which the small side wall portions are inserted respectively.

According to another aspect of the present invention, the flange portion and the side wall of the diffuser may have one-piece construction.

According to another aspect of the present invention, the flange portion and the side wall of the diffuser may be separate from each other.

According to another aspect of the present invention, the side wall may include a cylindrical portion and a collar portion that expands outward from a lower end of the cylindrical portion, the cylindrical portion may include the first side wall portion and the second side wall portion, and the collar portion may overlap the flange portion of the diffuser.

According to another aspect of the present invention, the flange portion of the diffuser may be provided with a claw portion engaged with an outer peripheral edge of the flange of the inflator.

According to another aspect of the present invention, a spacer may be interposed between the flange of the inflator and the flange portion of the diffuser.

According to another aspect of the present invention, the inner peripheral surface of the side wall of the diffuser may be provided with a plurality of protruding portions that contact the side peripheral surface of the body portion of the inflator.

According to another aspect of the present invention, the first side wall portions and the second side wall portions may be alternately provided in the circumferential direction.

According to another aspect of the present invention, in the diffuser, the first side wall portions may face each other with the central opening interposed therebetween, and the second side wall portions may face each other with the central opening interposed therebetween.

According to another aspect of the present invention, a distal end of a side wall portion rising from the annular attachment ring may be positioned lower than a distal end of the side wall of the diffuser.

### Advantageous Effects of Invention

According to the present invention, it is possible to easily assemble a diffuser to an inflator, and to control a flow path of a gas from an inflator.

### BRIEF DESCRIPTION OF DRAWINGS

FIG. 1 is a cross-sectional view showing an airbag device according to an embodiment.

FIG. 2 is an exploded perspective view showing the airbag device according to the embodiment.

FIG. 3 is a partially exploded perspective view showing the airbag device according to the embodiment.

FIG. 4 is a perspective view showing a diffuser.

FIG. 5 is a perspective view showing a diffuser and an inflator according to a second embodiment.

FIG. 6 is a perspective view of a diffuser according to a third embodiment as viewed from below.

FIG. 7 is an exploded perspective view showing the diffuser shown in FIG. 6.

FIG. 8 is a perspective view of the diffuser shown in FIG. 6 as viewed from above.

FIG. 9 is a perspective view showing the diffuser shown in FIG. 6 and the inflator as viewed from above.

FIG. 10 is a cross-sectional view of a part of the airbag device using the diffuser shown in FIG. 6.

FIG. 11 is a cross-sectional view of a part of the airbag device using the diffuser shown in FIG. 6.

### DESCRIPTION OF EMBODIMENTS

Embodiments of the present invention will be described below with reference to the drawings. In the following description, a 12 o'clock side and a 6 o'clock side of an airbag device for a driver seat are an upper side and a lower side when a steering wheel is viewed from front (from an occupant side extension direction of a steering shaft), a 3 o'clock side is a right side and a 9 o'clock side is a left side.

The airbag device 1 includes a folded airbag 2, an inflator 3 configured to inflate the airbag 2, a retainer 10 to which the airbag 2 and the inflator 3 are attached, an attachment ring 20 configured to attach the airbag 2 and the inflator 3 to the retainer 10, a diffuser 30 configured to restrict a flow direction of a gas from the inflator 3, a module cover 40 mounted on an occupant side of the retainer 10 so as to cover a folded body of the airbag 2, and the like. The retainer 10 and the diffuser 30 are made of metal which is iron or the like, and the module cover 40 is made of synthetic resin. The airbag 2 is made of cloth.

The inflator 3 is a disc type, and includes a disc-shaped body portion 3a, a flange 3b protruding from a side peripheral surface of the body portion 3a, bolt insertion holes 3c provided in the flange 3b, and gas ejection ports 3d provided on the side peripheral surface of the body portion 3a. A plurality of (particularly four or more, for example, eight) gas ejection ports 3b are formed at regular intervals in a circumferential direction of the body portion 3a. The gas ejection ports 3b is provided distal to the flange 3b, that is, on a front end side in a direction of insertion into the airbag 2.

The retainer 10 includes a main plate portion 11 that faces an occupant side of a steering hub portion. An inflator opening 12 into which the inflator 3 is fitted is formed near a center of the main plate portion 11, and a bolt insertion hole 13 into which a bolt 21 configured to fix the airbag 2 and the inflator 3 to the main plate portion 11 is inserted is formed in a peripheral portion of the inflator opening 12.

In this embodiment, the module cover 40 includes a canopy portion 41 configured to cover an occupant side of a folded body of the airbag 2, and a side wall portion 42 that protrudes from the canopy portion 41 to an anti-occupant side. The side wall portion 42 has a frame shape surrounding an entire circumference of the folded body of the airbag 2.

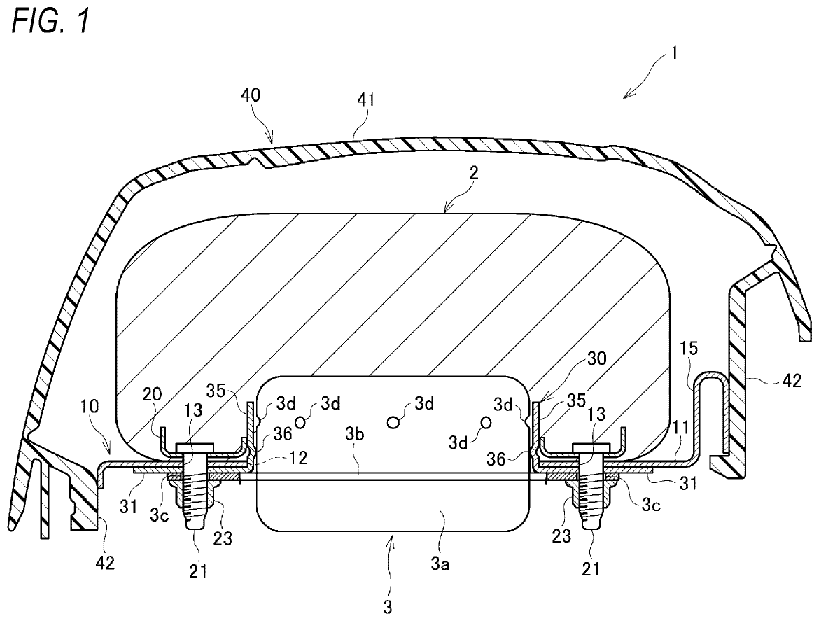

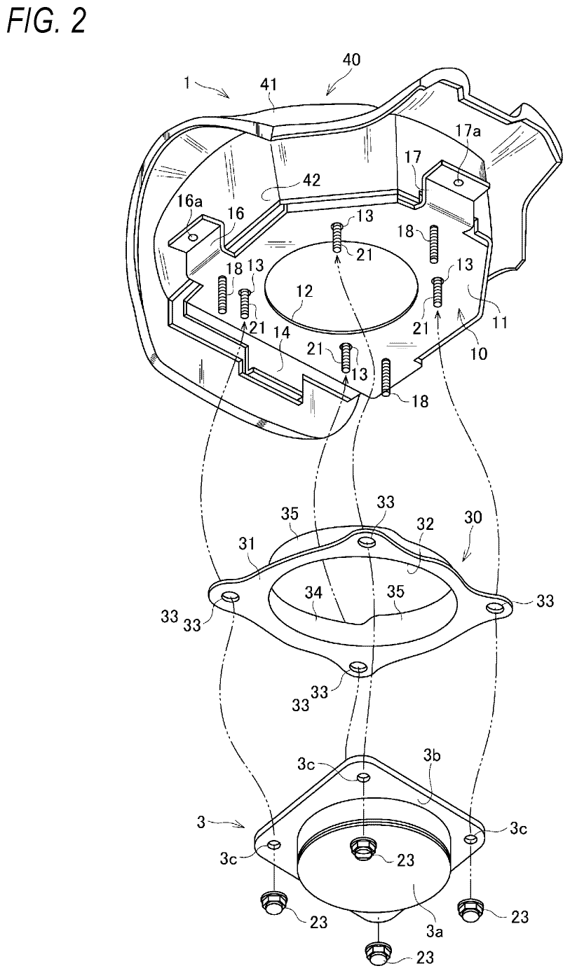

A first attachment portion 14 (FIG. 2) configured to attach a 12 o'clock side of the module cover 40 to the retainer 10 is provided on a 12 o'clock side of the retainer 10, and a second attachment portion 15 (FIG. 1) configured to attach a six o'clock side of the module cover 40 to the retainer 10 is provided on a 4 to 5 o'clock side and a 7 to 8 o'clock side. The retainer 10 is provided with overhanging pieces 16, 17, and each of the overhanging pieces 16, 17 is provided with a respective one of horn contacts 16a, 17a. Further, an attachment bolt 18 configured to connect the retainer 10 to a base plate (not shown) is provided upright on the retainer 10.

The attachment ring 20 has an annular shape that surrounds the inflator opening 12, and bolts (stud bolts) 21 are provided upright from four places in a circumferential direction.

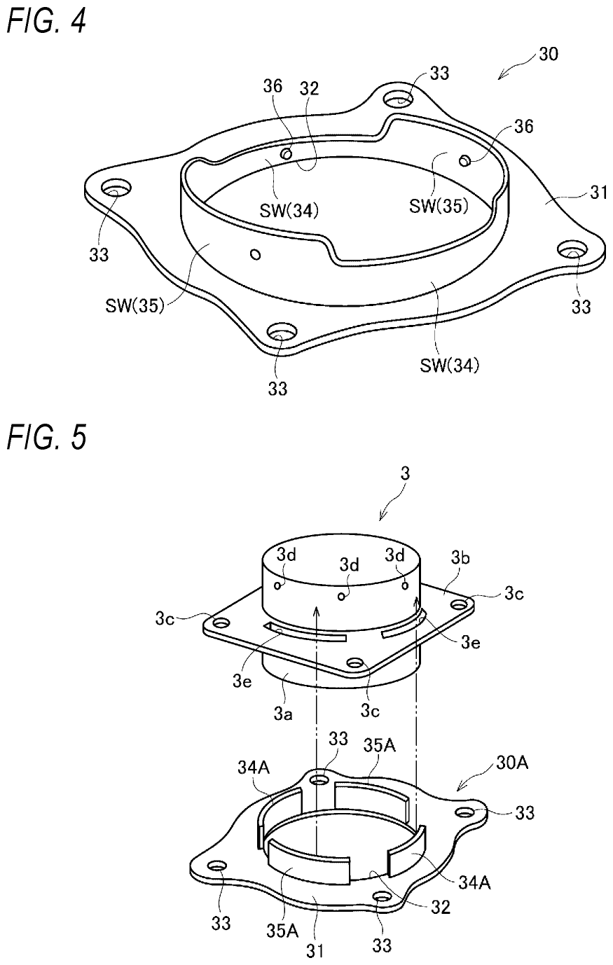

The diffuser 30 includes a flange portion 31 formed with a central opening 32 into which the inflator 3 is inserted into a central part, and a side wall SW (FIG. 4) rising from a peripheral portion of the central opening 32. The central opening 32 is circular. An outer peripheral edge of the diffuser 30 is substantially rectangular, and four corners of the outer peripheral edge extend in an expanding direction. Bolt insertion holes 33 are formed at ends of the four corners of the flange portion 31.

The side wall SW has a cylindrical shape, and a height of the side wall SW from the flange portion 31 changes midway in a circumferential direction. The side wall SW includes first side wall portions 34 and second side wall portions 35 each having a height larger than that of the first side wall portion 34. For example, the first side wall portions 34 and the second side wall portions 35 are alternately provided, and the first side wall portions 34 are provided on a 3 o'clock side and a 9 o'clock side, and the second side wall portions 35 are provided on a 6 o'clock side and a 12 o'clock side. In this example, the first side wall portions 34 face each other and the second side wall portions 35 face each other with the central opening 32 interposed therebetween.

A plurality of protrusions (protruding portions) 36 are provided on an inner peripheral surface of the side wall SW at predetermined intervals. For example, four protrusions 36 are provided. A height (a protrusion amount) of the protrusion 36 from the inner peripheral surface of the side wall SW is approximately 0.5 mm. For example, the four protrusions 36 are preferably arranged on the inner peripheral surface of the side wall SW at equal intervals in good balance in consideration of a position of a center of gravity of the diffuser 30. By providing the protrusions 36, a constant interval is formed between the inner peripheral surface of the side wall SW and an outer peripheral surface of the body portion 3a of the inflator 3.

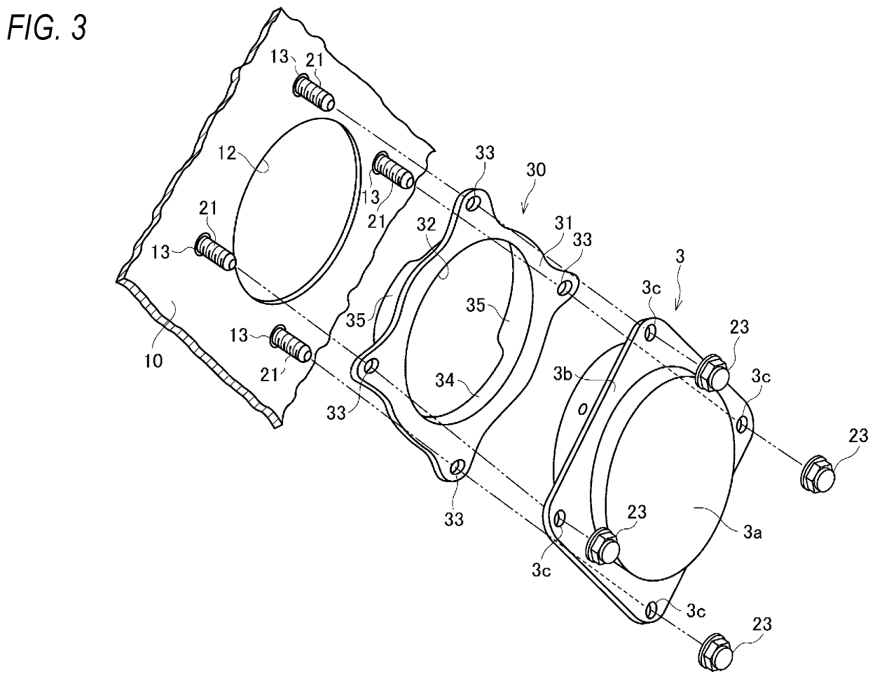

As shown in FIGS. 2 and 3, the diffuser 30 is faced to a surface of the retainer 10 on a side opposite to an occupant, the bolts 21 of the attachment ring 20 are inserted into the bolt insertion holes 33, and the side wall SW is inserted into the opening 12.

Then, by inserting a front side of the inflator 3 into the opening 12 (the opening 32), engaging the bolt insertion holes 3c with the bolts 21, and screwing nuts 23 to the bolts 21, the airbag 2, the inflator 3, and the diffuser 30 are attached to the retainer 10. After the diffuser 30 has been fitted into the inflator 3, the diffuser 30 and the inflator 3 may be inserted into the opening 12 of the retainer 10. The diffuser 30 can be easily assembled to the inflator 3.

The flange portion 31 of the diffuser 30 faces the flange 3b of the inflator 3, and is sandwiched between the flange 3b and an anti-occupant surface of the main plate portion 11 of the retainer 10.

The side wall SW of the diffuser 30 covers a side peripheral surface of the inflator 3. A distal end (an upper end) of the first side wall portion 34 does not reach the gas ejection port 3d of the inflator 3. A distal end of the second side wall portion 35 reaches the gas ejection port 3d of the inflator 3, and covers the gas ejection port 3d. The distal end of the second side wall portion 35 is lower than an upper surface (a distal end surface) of the body portion 3a of the inflator 3.

The protrusion 36 provided on the inner peripheral surface of the side wall SW of the diffuser 30 contacts the side peripheral surface of the inflator 3. Therefore, the second side wall portion 35 covers the gas ejection port 3d with a gap formed between the second side wall portion 35 and the gas ejection port 3d.

The airbag device 1 provided as described above is attached to a central part of a steering of an automobile.

When the inflator 3 is operated to inject a gas at a time of vehicle emergency, the airbag 2 is inflated, the canopy portion 41 of the module cover 40 is torn, and the airbag 2 is deployed in front of an upper body of an occupant to restrain the occupant.

In this embodiment, when the diffuser 30 is provided and the inflator 3 is operated to inject a gas, the gas from the gas ejection port 3d, which is provided higher than the distal end of the first side wall portion 34 and is not covered by the side wall SW (the first side wall portion 34), causes the airbag 2 to quickly inflate laterally.

The gas from the gas ejection port 3d covered by the second side wall portion 35 is distributed to a gas that strikes the second side wall portion 35 and is directed toward a side of the airbag 2 and a gas that is directed toward an occupant side (a vehicle rear side). Accordingly, the airbag 2 is inflated toward an occupant at a desired timing. A position and a circumferential length of the second side wall portion 35 are changed, so that the number of the gas ejection ports 3d covered by the second side wall portion 35 can be changed, and a flow path of the gas from the inflator 3 can be controlled.

A distal end of a side wall portion rising from an inner peripheral edge of the attachment ring 20 is positioned lower than a distal end of the side wall SW. Accordingly, it is possible to prevent the gas from the gas ejection port 3d from directly hitting a side wall of the attachment ring 20.

FIG. 5 shows a second embodiment. In FIG. 5, the diffuser 30A is fitted from below the inflator 3. In this embodiment, a side wall includes a plurality of small side wall portions. In this embodiment, two types of small side wall portions having different heights are provided as the small side wall portions. Each small side wall portion rises from the peripheral portion of the central opening 32 of the diffuser 30A. One small side wall portion is a first side wall portion 34A, and the other small side wall portion is a second side wall portion 35A having a height from the flange portion 31 larger than that of the first side wall portion 34A. The first side wall portion 34A and the second side wall portion 35A are alternately provided at intervals.

The flange 3b of the inflator 3 is provided with a plurality of insertion holes 3e, which is configured to allow the first side wall portion 34A and the second side wall portion 35A to be inserted, on the same circumference at intervals.

When the diffuser 30A is fitted from below the inflator 3, the first side wall portion 34A and the second side wall portion 35A, which are inserted through the insertion holes 3e, surround the side peripheral surface of the inflator 3. The second side wall portion 35A covers the gas ejection port 3d. The first side wall portion 34A does not reach the gas ejection port 3d. When the inflator 3 and the diffuser 30A are attached to the retainer 10, the flange 3b of the inflator 3 is sandwiched between the flange portion 31 of the diffuser 30A and the anti-occupant surface of the main plate portion 11 of the retainer 10.

The other reference numerals in FIG. 5 denote the same parts as those described above.

The other configuration of the airbag device having the configuration in FIG. 5 are the same as that of the airbag device in FIGS. 1 to 4.

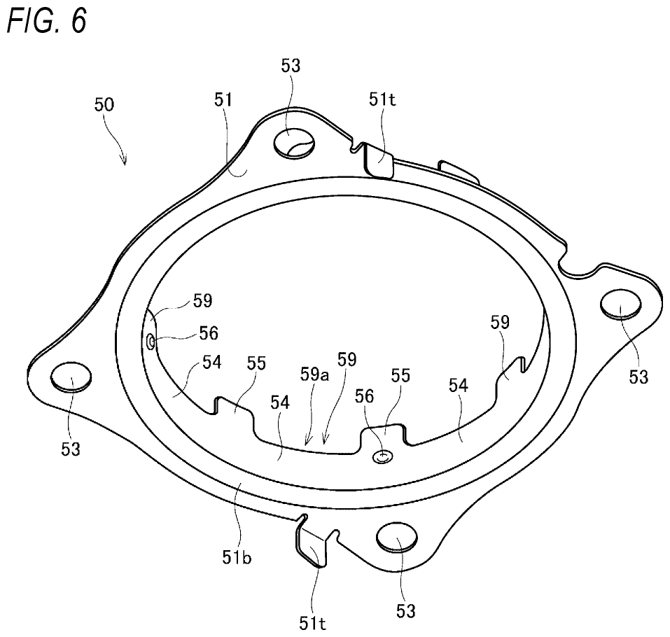

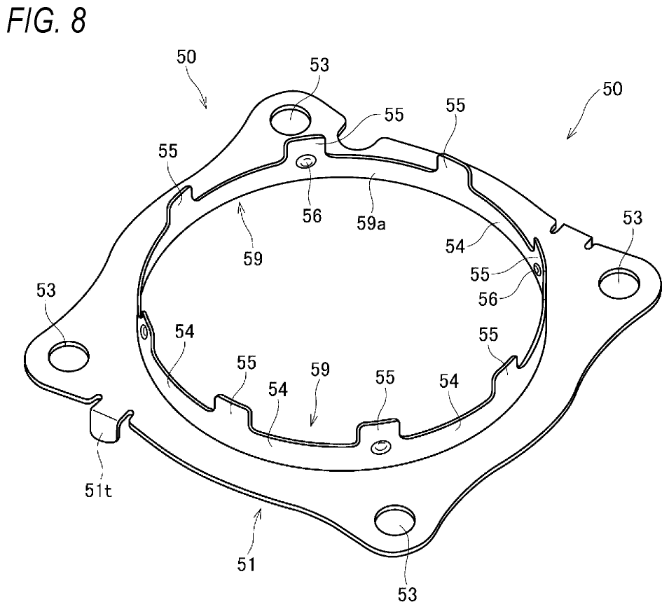

FIGS. 6 to 9 show a diffuser 50 used in a third embodiment.

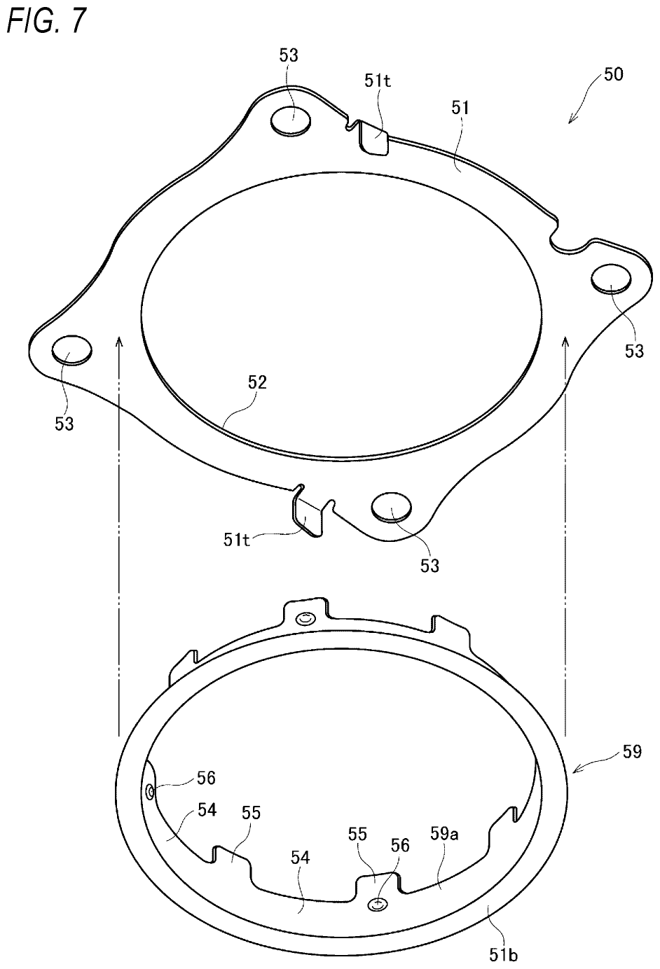

The diffuser 50 includes a flange portion 51 formed with a central opening 52 (FIG. 7) into which the inflator 3 is inserted into a central part, and a side wall 59 that is separate from the flange portion 51. The central opening 52 is circular. An outer peripheral edge of the flange portion 51 is substantially rectangular, and four corners of the outer peripheral edge extend in an expanding direction. Bolt insertion holes 53 are formed at ends of the four corners of the flange portion 51.

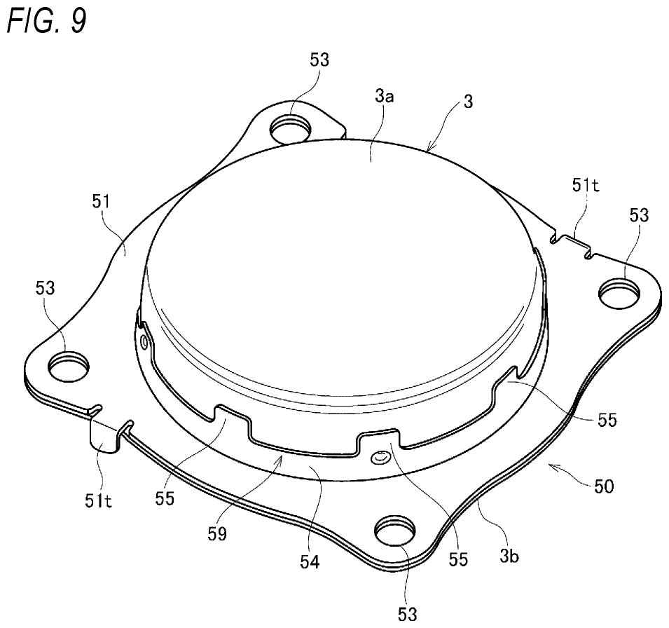

Claw portions 51t are folded from the outer peripheral edge of the flange portion 51. The flange portion 51 has a flat plate shape except for the claw portions 51t. In the drawing, the claw portions 51t are folded from a pair of opposing sides and a total of two claw portions 51t are provided. However, the claw portions 51t may be provided on all four sides. As shown in FIG. 9, the claw portions 51t are engaged with an outer edge of the flange 3b of the inflator 3.

The side wall 59 includes a cylindrical portion 59a and a collar portion 59b that expands outward from a lower end of the cylindrical portion 59a. The collar portion 59b has an annular plate shape.

The cylindrical portion 59a has a short cylindrical shape.

A height of the cylindrical portion 59a from the collar portion 59b changes midway in a circumferential direction, and includes first side wall portions 54 and second side wall portions 55 each having a height larger than that of the first side wall portion 54. For example, the first side wall portion 54 and the second side wall portion 55 are alternately provided. In this embodiment, eight first side wall portions 54 are provided, but the present invention is not limited thereto.

A plurality of protrusions (protruding portions) 56 are provided on an inner peripheral surface of the side wall 59 at predetermined intervals. For example, four protrusions 56 are provided. A height (a protrusion amount) of the protrusion 56 from the inner peripheral surface of the side wall 59 is approximately 0.5 mm. For example, the four protrusions 56 are preferably arranged on the inner peripheral surface of the side wall 59 at equal intervals in good balance in consideration of a position of a center of gravity of the diffuser 50. By providing the protrusions 56, a constant interval is formed between the inner peripheral surface of the side wall 59 and an outer peripheral surface of the body portion 3a of the inflator 3.

As shown in FIG. 7, the diffuser 50 is formed by inserting the cylindrical portion 59a into the central opening 52 of the flange portion 51 and overlapping the collar portion 59b with the flange portion 51.

As shown in FIG. 9, the body portion 3a of the inflator 3 is fitted into the diffuser 50, and the flange 3b of the inflator 3 is overlapped on the flange portion 51 of the diffuser 50. The flange 3b and the flange portion 51 have the same outer peripheral edge, and the claw portion 51t engages with the outer peripheral edge of the flange 3b. Accordingly, the inflator 3 non-rotatably engages with the flange portion 51 of the diffuser 50.

Next, the side wall 59 of the diffuser 50 is rotated in the circumferential direction, and the second side wall portion 55 is faced to a part of the gas ejection ports 3d of the inflator 3.

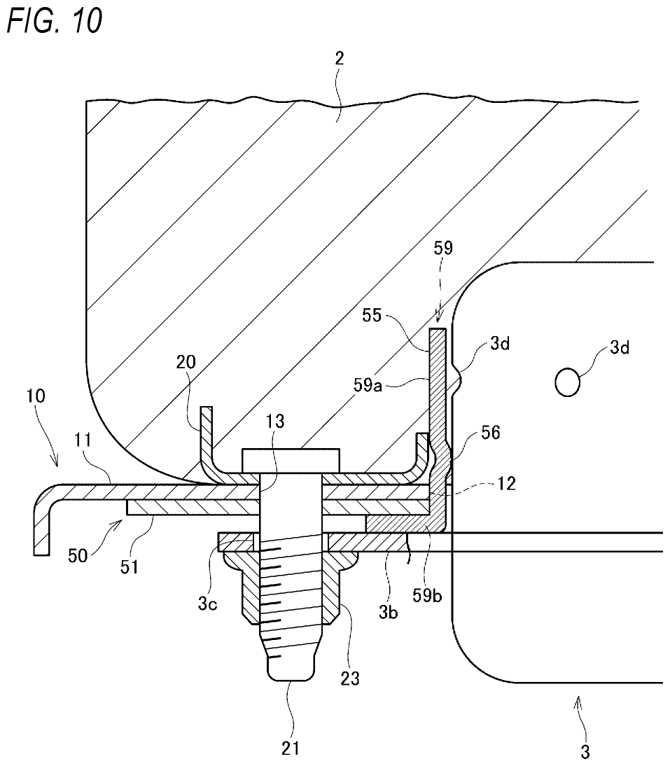

After the inflator 3 and the diffuser 50 are combined in this manner, as shown in FIG. 10, by facing the diffuser 50 and the inflator 3 to the surface of the retainer 10 on a side opposite to an occupant, inserting a front side of the inflator 3 into the opening 12, engaging the bolt insertion holes 3c with the bolts 21, and screwing the nuts 23 to the bolts 21, the airbag 2, the inflator 3, and the diffuser 50 are attached to the retainer 10.

The flange portion 51 and the collar portion 59b of the diffuser 50 are sandwiched between the flange 3b of the inflator 3 and the main plate portion 11 of the retainer 10.

The side wall 59 of the diffuser 50 covers a side peripheral surface of the inflator 3. A distal end (an upper end) of the first side wall portion 54 does not reach the gas ejection port 3d of the inflator 3. A distal end of the second side wall portion 55 reaches the gas ejection port 3d of the inflator 3, and covers the gas ejection port 3d. The distal end of the second side wall portion 55 is lower than an upper surface (a distal end surface) of the body portion 3a of the inflator 3.

The protrusion 56 provided on the inner peripheral surface of the side wall 59 of the diffuser 50 contacts the side peripheral surface of the inflator 3. Therefore, the second side wall portion 55 covers the gas ejection port 3d with a gap formed between the second side wall portion 55 and the gas ejection port 3d.

The other configuration according to this embodiment is the same as those according to the embodiments in FIGS. 1 to 5, and the other same reference numerals denote the same parts.

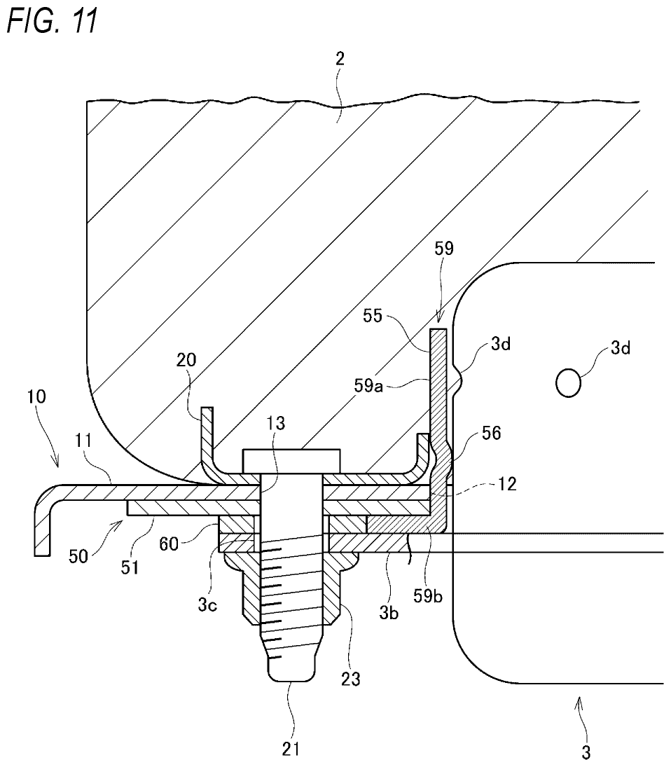

As shown in FIG. 11, a spacer 60 may be interposed so as to fill a space between the flange portion 51 of the diffuser 50 and the flange 3b of the inflator 3.

In the above-described embodiment, a configuration has been described in which the side wall SW of the diffuser 30 is not formed with a gas passage opening. However, the side wall SW may be formed with one or more holes.

The present invention is also applicable to an airbag device other than a driver seat airbag device.

The present invention is not limited to the above-described embodiments and can be embodied by modifying components in an implementation stage without departing from the gist of the present invention. Various aspects of the invention can be formed through an appropriate combination of a plurality of components disclosed in the above-described embodiments. For example, some components may be deleted from all the components shown in the embodiments. Further, the components according to different embodiments may be appropriately combined.

Although the present invention has been described in detail using specific embodiments, it will be apparent to those skilled in the art that various changes can be made without departing from the spirit and the scope of the present invention.

This application is based on Japanese Patent Application No. 2018-085494, filed on Apr. 26, 2018, entirety of which is incorporated by reference.

### REFERENCE SIGNS LIST

1 airbag device
2 airbag
3 inflator
10 retainer
11 main plate portion
20 attachment ring
21 bolt
30, 50 diffuser
40 module cover

1. An airbag device comprising:
an airbag;
an inflator configured to inflate the airbag, the inflator including a body portion, a flange protruding from a side peripheral surface of the body portion, and a gas ejection port provided on the side peripheral surface of the body portion distal to the flange;
a retainer to which the airbag and the inflator are attached by an attachment ring;
a diffuser configured to restrict a flow direction of a gas from the inflator; and
a module cover covering the airbag,
wherein the airbag and the retainer are respectively provided with inflator openings into which the inflator is inserted,
wherein the attachment ring surrounds the inflator openings in the airbag,
wherein the attachment ring includes a plurality of bolts that are provided upright at intervals in a circumferential direction,
wherein each bolt is inserted into bolt insertion holes respectively provided in the airbag, the retainer, and the flange of the inflator, and a nut is screwed,
wherein the diffuser includes:
a flange portion that is provided with a central opening into which the inflator is inserted into a central part and that faces the flange of the inflator;
a side wall that rises from a peripheral portion of the central opening of the flange portion and that surrounds the side peripheral surface of the body portion of the inflator; and
a hole that is provided in the flange portion and into which the bolt is inserted,
wherein the side wall includes a first side wall portion and a second side wall portion having a height from the flange portion larger than that of the first side wall portion, and
wherein a distal end of the second side wall portion is positioned higher than the gas ejection port of the inflator.

2. The airbag device according to claim 1,
wherein the distal end of the second side wall portion is positioned lower than a distal end surface of the body portion of the inflator.

3. The airbag device according to claim 1,
wherein a distal end of the first side wall portion is positioned lower than the gas ejection port.

4. The airbag device according to claim 1,
wherein the side wall of the diffuser is provided with no gas passage opening.

5. The airbag device according to claim 1,
wherein the side wall of the diffuser has a cylindrical shape.

6. The airbag device according to claim 1,
wherein the flange of the inflator is interposed between the retainer and the flange portion of the diffuser.

7. The airbag device according to claim 6,
wherein the side wall of the diffuser includes a plurality of small side wall portions arranged in the circumferential direction, and
wherein the flange of the inflator is provided with insertion holes through which the small side wall portions are inserted respectively.

8. The airbag device according to claim 1,
wherein, the flange portion and the side wall of the diffuser have one-piece construction.

9. The airbag device according to claim 1,
wherein, the flange portion and the side wall of the diffuser are separate from each other.

10. The airbag device according to claim 9,
wherein the side wall includes a cylindrical portion and a collar portion that expands outward from a lower end of the cylindrical portion,
wherein the cylindrical portion includes the first side wall portion and the second side wall portion, and
wherein the collar portion overlaps the flange portion of the diffuser.

11. The airbag device according to claim 9,
wherein the flange portion of the diffuser is provided with a claw portion engaged with an outer peripheral edge of the flange of the inflator.

12. The airbag device according to claim 9,
wherein a spacer is interposed between the flange of the inflator and the flange portion of the diffuser.

13. The airbag device according to claim 1,
wherein the inner peripheral surface of the side wall of the diffuser is provided with a plurality of protruding portions that contact the side peripheral surface of the body portion of the inflator.

14. The airbag device according to claim 1,
wherein the first side wall portions and the second side wall portions are alternately provided in the circumferential direction.

15. The airbag device according to claim 1,
wherein, in the diffuser, the first side wall portions face each other with the central opening interposed therebetween, and the second side wall portions face each other with the central opening interposed therebetween.

16. The airbag device according to claim 1,
wherein the attachment ring includes a wall portion rising from an inner peripheral edge, and
wherein a distal end of the wall portion is positioned lower than a distal end of the side wall of the diffuser.
